(19) United States
(12) Patent Application Publication
(10) Pub. No.: US 2020/0372375 A1
(43) Pub. Date: Nov. 26, 2020

(54) Method and System for Predicting Crude Oil or Petroleum Products Loaded On-board Vessels

(71) Applicant: DA-DESK FZ-LLC, Dubai Outsource City (AE)

(72) Inventors: Amit Rajendra Pathak, Dubai (AE); Bruno Jerzy Deszczynski, Dubai (AE)

(73) Assignee: DA-DESK FZ-LLC, Dubai Outsource City (AE)

(21) Appl. No.: 16/418,240

(22) Filed: May 21, 2019

(51) Int. Cl. G06N 5/02; G06N 3/02; B63B 25/02; G08G 3/00

(52) U.S. Cl. CPC G06N 5/025; G06N 3/02; B63B 2025/027; G08G 3/00; B63B 25/02

(57) ABSTRACT

An accurate predictive methodology for crude oil markets. Use of both technology and domain expertise to build a robust predictor of crude oil cargo (and its derivatives) loading. The method relies on a plurality data sources to verify the accuracy of the data. AIS for locating a vessel and machine learning are employed for prediction. In some cases, crude oils are traded using a synonym. Synonyms have been accounted for in this method wherever available via an extensive commodity hierarchy taxonomy. The method provides benchmarking information on basis the port calls, SOFs (statements of facts) and ullage Reports to select the best berth for a commodity. The system and method provide for improved berth selection and facilitate quality improvements in cargo management systems. The method improves the currently available business intelligence related to cargo at berth and improves quality of information or shipping executives, managers, charterers and traders.

### BACKGROUND

Navigating, transporting, managing, predicting and coordinating ocean vessel traffic is an age-old problem faced by the maritime industry for centuries. The maritime Automatic Information System (AIS) provides some information to address these problems. The Automatic Identification System (AIS) is an automatic tracking system used on ships and by vessel traffic services (VTS) for identifying and locating vessels by electronically exchanging data with other nearby ships, AIS base stations, and satellites. When satellites are used to detect AIS signatures then the term Satellite-AIS (S-AIS) is often used. AIS information supplements marine radar, which continues to be the primary method of collision avoidance for water transport.

Information provided by AIS equipment, such as unique identification, position, course and speed, can be displayed on a screen or networked device. AIS is intended to assist a vessel's watchstanding officers and allow maritime authorities to track and monitor vessel movements. Conventionally, AIS integrates a standardized VHF transceiver with a positioning system such as a GPS receiver, with other electronic navigation sensors, such as a gyrocompass or rate of turn indicator. Vessels fitted with AIS transceivers can be tracked by AIS base stations located along coast lines or, when out of range of terrestrial networks, through a growing number of satellites that are fitted with special AIS receivers which are capable of de-conflicting a large number of signatures. The base stations and satellites are coupled to networks for providing the AIS information to remote users.

The International Maritime Organization's International Convention for the Safety of Life at Sea requires AIS to be fitted aboard international voyaging ships with gross tonnage (GT) of 300 or more, and all passenger ships regardless of size. Accordingly, AIS is widely used in marine transportation systems.

While AIS information is becoming widely available, there is a need to extract meaningful data from this information for efficient operation of marine transportation systems. Moreover, there is a need to couple the AIS information with other transportation and port information to efficiently schedule and price transportation requirements. Additionally, loading and unloading times may be fairly well estimated, however, there may be wide variations in port operation times depending on terminal equipment, seasonality, port, berth and terminal utilization rates, as well as port operation characteristics and other conditions in the port area that affect the operation of those ports.

A challenge with complete reliance on AIS data is the “noise” in the ‘Destination’ and ‘Draft’ columns. Both these columns are updated by the crew and there is no regulation to mandate strict rules for updating these fields at the correct and designated intervals. Accordingly, supplemental information may be required to evaluate cargoes and transportation logistics, especially in the crude oil markets.

The crude-oil market is one of the most closely watched markets with very little open source information available. Many traders rely on information brokering houses for gathering data and leveraging this information for their trades. A detailed understanding of the shipping market can play a pivotal role in deciphering the rules of the crude oil market and the movement of parcels across the globe.

To supplement AIS information, so-called “artificial intelligence” systems may be employed. For example, and without limitation, artificial neural networks (ANN) or connectionist systems are computing systems vaguely inspired by the biological neural networks that constitute animal brains. The neural network itself is not an algorithm, but rather a framework for many different machine learning algorithms to work together and process complex data inputs. Such systems “learn” to perform tasks by considering examples, generally without being programmed with any task-specific rules. For example, in image recognition, they might learn to identify images that contain cats by analyzing example images that have been manually labeled as “cat” or “no cat” and using the results to identify cats in other images. They do this without any prior knowledge about cats, for example, that they have fur, tails, whiskers and cat-like faces. Instead, they automatically generate identifying characteristics from the learning material that they process. Similarly, port call and vessel loading information may be used to “teach” and ANN about crude-oil shipping.

An ANN is based on a collection of connected units or nodes called artificial neurons, which loosely model the neurons in a biological brain. Each connection, like the synapses in a biological brain, can transmit a signal from one artificial neuron to another. An artificial neuron that receives a signal can process it and then signal additional artificial neurons connected to it.

In view of the foregoing, reliable quantification, estimation and scheduling are needed to maximize overall transport efficiency for ocean-going markets, including, but not limited to, the crude oil markets.

### BRIEF DESCRIPTION OF THE DRAWINGS

FIG. 1 shows a functional block diagram of a client server system.

FIG. 2 illustrates steps in a method that may be employed in certain embodiments.

FIG. 3 shows a method of extracting data from reports to predict the next port for a journey of an oil tanker.

FIG. 4 is a flow diagram of a method for updating cargo data.

### SUMMARY

Disclosed herein is a system and method for determining operating characteristics of a maritime vessel by receiving AIS information, including vessel draft information, analyzing vessel location information, including analyzing the history of vessel positions at loading and discharging stations, analyzing cargo records including crude oil and crude oil mixtures, and analyzing that information to determine key crude oil market information to facilitate more efficient handling of crude oil. Certain embodiments provide for calculations of a vessel characteristic Tonnes Per Centimeter Immersion (TPCI) which may be associated with certain types of cargos. Moreover, artificial intelligence using tools such as neural networks and other prediction methodologies may be employed to estimate key missing data. The system and method provide for improved vessel performance metrics and facilitate quality improvements in oil-based cargo management systems.

Vessel draft information may be near supplied in port or underway and corrective calculations may be employed to associate the changes in cargo to the type of cargo by analyzing the vessel's historic locations. These historic locations may be identified with known cargo load and discharge stations, for example fueling stations or oil cargo terminals, to determine the type and amount of cargo loaded or discharged. In addition, historical adding information may be quantified using ANN methodologies.

In the present disclosure, computer-based data mining algorithms have been used to fill gaps in the data. With current information gathering practices relying heavily on information houses with little to moderate coverage, these computer driven algorithms are well positioned to cover the entire globe. Apart from allowing global coverage, the described system is cost effective and easily scalable.

The cargo data may include not only information about over 600 distinct crude oil blends/grades, but may also dive deep into their characteristics such API gravity, Sulphur content, C1-C4 ratios and the most common clean petroleum products extracted from these raw oils. Every crude oil blend has an assigned loading location. This information is gathered primarily from a commercially available anonymized database which provides an accurate summary of the loaded/discharged cargo and also from the port documentation gathered over time from port authorities. The cargo database may also include comprehensive information about the synonyms, abbreviations and trade names of the crude oil grades. Based on characteristics of the oil, every crude oil has been assigned a category based on the CAPLINE system. This category enables classification of the crude oil blends into ‘Sour’, ‘Intermediate’ and ‘Sweet’. The database may be populated by taking into consideration established classification methodologies as well as the available crude oil assays. The crude oil assays provide detailed insights into the characteristics like pour point, carbon residue, viscosity, h2s content, vanadium content, nickel content, salt content and organic chlorides content.

The crude Oil Trade data may also include information related to historical and upcoming fixtures. The fixtures data is gathered primarily from brokers, and public information. This authentic data is supplemented by additional data from other information houses. The historic fixtures play a key role in understanding the charterer and shipper for each crude oil parcel. These historic trends provide for better predictive and analytical modelling of the dataset.

With the advent of the AIS, tracking ships has become relatively easier. However, given the understanding that AIS data is not totally reliable, the embodiments herein include other data sources for the data modelling. For example, the statement of facts and ullage reports provide a clear indication of the cargo carried in some cases. This information can be used effectively to populate missing data points by using machine learning algorithms. These algorithms may be both unsupervised as well as supervised.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventors contemplate using those techniques, and think they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “Association Rules” generally refers to rules, such as if-then-else statements, that help to show the probability of relationships between data items within large data sets in various types of databases. Association rule mining, at a basic level, may involve the use of machine learning models to analyze data for patterns, or co-occurrence, in a database and identify frequent if-then associations, which may be applied as rules.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “Fixture” generally refers to the conclusion of charter negotiations between owner and charterer, when an agreement has been reached to charter a vessel. A Fixture generally refers to a “fixed” vessel, which means there is a fully fixed Recap with the chartering conditions removed.

An International Maritime Organization (IMO) number is a unique reference for ships, registered shipowners and management companies.

The term “Recap” generally refers to the document transmitted when a fixture has been agreed, setting forth all of the negotiated terms and details so far. It is shorthand for Recapitulation of Agreed Terms between a ship owner and a charterer. This is the operative document until the charter party is drawn up.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value but might be with respect to a measure or value held by that measurement or value at another place or time.

The terms “structured data” and “structured data source” generally means a coherent way to save and access information such as in a database, XML file and the like.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “virtual machine” or “VM” generally refers to a self-contained operating environment that behaves as if it is a single computer even though it is part of a separate computer or may be virtualized using resources from multiple computers.

### Detailed Description

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), AIS transmitters and receivers, laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device or effectuated remotely as a virtual machine.

### Client-Server Processing

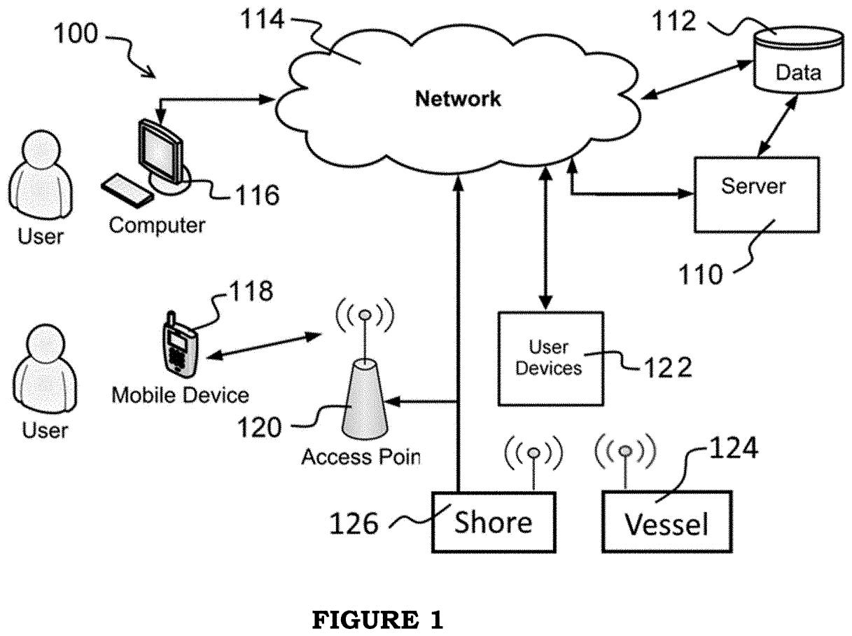

FIG. 1 shows a functional block diagram of a client server system 100 that may be employed for some embodiments according to the current disclosure. In the FIG. 1, a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

FIG. 1 includes a representative vessel 124 which operates to collect AIS information. The AIS information is wirelessly coupled to a shore station 126, generally using conventional FM radio or satellite communications systems. The AIS information is transferred through the network 114 to a data storage system 112.

Conventionally, client-server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions are conventionally known including applets and are written in a variety of languages including Java and JavaScript.

Client-server applications also provide for software-as-a-service (SaaS) applications where the server provides software to the client on an as-needed basis.

In addition to the transmission of instructions, client-server applications also include transmission of data between the client and server. Often, this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein, a display engine, a data engine, an execution engine, a user interface (UI) engine, and the like may be employed. These engines may seek and gather information about events from remote data sources.

In this disclosure, the above described systems also include radio and satellite transmission systems as well as AIS information collection devices and the associated networks employed in the aforementioned AIS systems.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

In addition, the information, including AIS messages, may be stored in a structured data store for sourcing the data when needed. This may include a series of discrete messages or data or may involve a larger aggregated message including information from multiple messages, including those messages appended as described herein. Accordingly, method steps that call for adding information, such as status, to a message, may be effectuated by adding a record to a structured data store associated with a particular ship or vessel or modifying an existing record to include additional information.

### AIS Data

An AIS transceiver sends the following data every 2 to 10 seconds depending on a vessel's speed while underway, and every 3 minutes while a vessel is at anchor:
The vessel's Maritime Mobile Service Identity (MMSI)—a unique nine-digit identification number.
Navigation status—“at anchor”, “under way using engine(s)”, “not under command”, etc.
Rate of turn—right or left, from 0 to 720 degrees per minute.
Speed over ground—0.1-knot (0.19 km/h) resolution from 0 to 102 knots (189 km/h).
Positional accuracy: Longitude—to 0.0001 minutes, Latitude—to 0.0001 minutes.
Course over ground—relative to true north to 0.1°.
True heading—0 to 359 degrees (conventionally from a gyrocompass).
True bearing at own position; 0 to 359 degrees.
UTC Seconds—The seconds field of the UTC time when these data were generated. A complete timestamp is conventionally not transmitted.

In addition, the following data is broadcast every 6 minutes:
IMO ship identification number—a seven-digit number that remains unchanged upon transfer of the ship's registration to another country.
Radio call sign—international radio call sign, up to seven characters, assigned to the vessel by its country of registry.
Name of vessel—up to 20 characters.
Type of ship/cargo.
Dimensions of ship—to the nearest meter.
Location of positioning system's (e.g., GPS) antenna on board the vessel—in meters aft of bow and meters port of starboard.
Type of positioning system—such as GPS, DGPS or LORAN-C.
Draft of ship—0.1 meters to 25.5 meters.
Destination—max. 20 characters.
ETA (estimated time of arrival) at destination—UTC month/date hour: minute.
optional: high precision time request, a vessel can request other vessels provide a high precision UTC time and datestamp.

In addition to AIS data, proprietary data may also be included in certain embodiments.

In a conventional AIS installation most of data fields are updated automatically by querying ship's sensors. However, destination and draft data are often entered manually by the vessel crew. Data entry by hand is prone to errors, and it can be updated with a time delay from when the draft or destination changes. Since it is manually entered, it is not always updated until the vessel is finished loading or unloading cargo. For example, the ship's crew updates AIS data field “draft of ship” immediately after completion of cargo operations and while the ship is still at the berth, or often the ship's crew updates AIS draft data field (with a delay) while the ship is no longer at the berth and/or is no longer within the port limits.

A vessel's draft is indicative of its loading and a change in draft, except for minor variations, indicates a change in the vessel's loading status. Draft of a ship may change by 0.1 to 15 meters depending on the cargo. The table 1 below shows AIS draft data for a vessel.

TABLE 1

| RowNr | Timestamp | Draft value (meters) |
|---|---|---|
| 01. | 05/01/201800:00 | 6.3 m |
| 02. | 05/01/201801:00 | 6.3 m |
| 03. | 05/01/201802:00 | 6.3 m |
| 04. | 05/01/201803:00 | 6.3 m |
| 06. | 05/01/201804:00 | 6.3 m |
| 07. | 05/01/201806:00 | 10.3 m |
| 08. | 05/01/201807:00 | 10.3 m |
| 09. | 05/01/201808:00 | 10.3 m |
| 10. | 05/01/201809:00 | 10.3 m |
| . . . | | |
| 40. | 05/03/201804:00 | 10.3 m |
| 41. | 05/03/201805:00 | 7.5 m |
| 42. | 05/03/201806:00 | 10.3 m |
| 43. | 05/03/201807:00 | 10.3 m |
| 44. | 05/03/201808:00 | 10.3 m |

As per the above table, at rows 06-07, draft value changed from 6.3 to 10.3 meters which is by 4.00 meters. Here, a recording system may record a “Loading” operation with the Timestamp of 05/01/2018 06:00.

At rows 40, 41 and 42, draft value charged from 10.3 to 7.5 meters and then back to 10.3 m. In this case, row 41 may be considered as an outlier and omitted from any analysis, because the change of draft value happened during a very short timeframe (within 2 hours). Generally, such outliers can be related to errors in AIS data transmission and may be accordingly ignored.

### Average Draft Variation

The amount of draft change transmitted by AIS is generally a function of the great variety of vessels sizes. Merchant cargo vessel displacement varies from 10.000 deadweight tons (DWT) to 450.000 DWT and vessel length reaches 400 meters. This makes uniformity generalization subject to large errors.

However, the applicants, by analyzing a representative subset of global vessels fleet and its historical AIS Draft data, determined that draft value variance is proportional to the vessel size. The table below details observed draft minimums and maximums for different vessel sizes, as well as, observed draft standard deviation (STDEV), which is expressing by how much the draft value observations differ from the mean value.

TABLE 2

| | Observed min. | Observed max. | Observed standard |
|---|---|---|---|
| DWT | draft | draft | deviation |
| 400000 | 8 | 23.5 | 4.97 |
| 300000 | 8 | 23.5 | 4.30 |
| 200000 | 8 | 19 | 4.05 |
| 131000 | 7 | 16 | 1.94 |
| 51000 | 5 | 12.5 | 1.94 |
| 17000 | 4 | 8 | 0.77 |

The STDEV value per vessel may be used as the threshold for draft value change. Hence, to record a vessel operation, the draft value change would need to exceed the threshold determined by the STDEV. For example, a 400,000 DWT vessel draft has changed from 20.5 to 20.0 meters (0.5 meters). Since this amount is less than the 4.97 meters threshold for the vessel the draft change would not be recorded. This relatively insignificant draft value change of 0.5 meters may be a result of vessel de-ballasting or other reasons not related to vessel cargo operations. Whereas a draft change of 6 meters would indicate a change of cargo.

### Tonnes Per Centimeter Immersion

Additionally, it is possible to estimate the amount (metric tons) of cargo loaded or discharged. This can be accomplished by using the vessel characteristic Tonnes Per Centimeter Immersion (TPCI), which expresses the number of tonnes required to alter the draft of a vessel by one centimeter. The TPCI varies with the draft and with the water density. Changes in draft cause a change in displacement and the TPCI assists in calculating the change. TPCI can be calculated by the formula:

TPCI=(A)×(d)/100
where A=area of water plane at a certain draught and
d=density of water in which the ship floats.

Knowing the change in draft, provides for a calculation of the change in tonnage being carried by the vessel.

### Vessel Location

In some embodiments, when a vessel cargo operation is recorded, a location may be assigned to the vessel cargo operation. The location may be a load/discharge station such as a port, terminal, off-shore transshipment zone, transfer zone, lightering zone, anchorage or other similar marine facility. Some embodiments may assign the nearest load/discharge station to the cargo operation based on the current vessel position. In alternative embodiments, the vessel's historical positions may be queried from a structured data store together with known load/discharge stations. These location databases may contain pre-defined geofences of these marine locations. Once queried, the valid load/discharge station may be recorded with the cargo operation information.

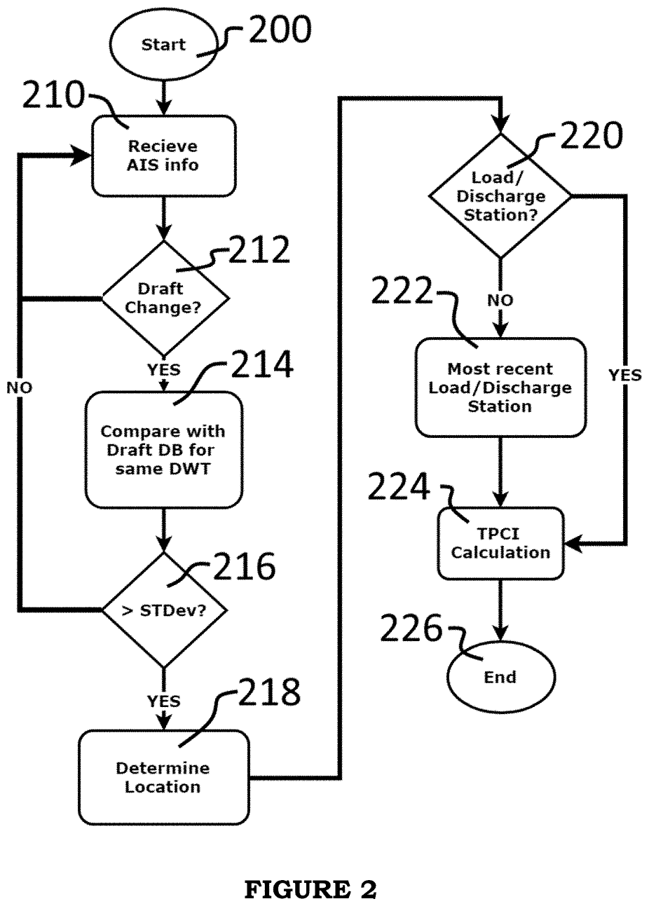

FIG. 2 illustrates steps in a method that may be employed in certain embodiments.

The method begins at a flow label 200.

At a step 210 a system, such as a processor or server, receives AIS information. This reception may be from a network such as the Internet.

At a step 212 the AIS is compared to historical data to determine if there is a change in a vessel's draft. If there is no appreciable change, then the method returns to the step 210. Otherwise the method proceeds to a step 214.

At the step 214 the standard deviation for the vessels weight class is queried from a data store.

At a step 216 the change in draft is compared to the standard deviation of draft changes from the step 214 (or a default limit, if employed). If the change in draft does not exceed the STDEV (or the default), then the method proceeds to the step 210. Otherwise the method proceeds to a step 218.

At the step 218 the vessel's location is determined.

At a step 220 a test is made to determine if the vessel in in a load/discharge station. If yes, the method proceeds to a step 224. Otherwise, the method proceeds to a step 222.

At the step 222 the most recently visited load/discharge station is associated with the change in draft operation.

At the step 224 a TPCI calculation is performed.

At a flow label 226 the method ends.

One having skill in the art will appreciate that not every step in the method of FIG. 2 needs to be performed to effectuate certain embodiments of the present disclosure. Moreover, the steps displayed do not need to be performed in the order presented.

The method disclosed herein may periodically interact with data sources and data stores for recording receiving, storing and reporting on the relevant information. These data sources and stores may be local to a server or remotely coupled to a system through a network such as the Internet.

### Cargo at Berth Predictor

The cargo at berth predictor(C@B) is a mix of technology and domain expertise combining AIS and Machine Learning (ML) algorithms. For example, and without limitation, Association Rule Learning. A predictive tool may incorporate several parameters critical to decision making in the shipping industry. These parameters take into account both quantitative and qualitative aspects of the information gathered and presented. One embodiment of the present disclosure may relate to the development of a decision support system capable of providing quality inputs which are validated through technical and regulatory filters. This allows the decision makers to develop a better understanding of the shipping market and make prudent decisions based on information displayed on an interactive interface.

This embodiment may rely on historical, current and dynamic information. Historical information plays a pivotal role in defining the logic behind the tool whereas the current and dynamic information aspects help in keeping the tool updated and geared for operation in preset day-scenario.

With AIS the voyage-related information includes ship's draught, Hazardous cargo (type), destination and the Estimated Time of Arrival (ETA). The destination field in the AIS allows for free text of up to a maximum of 20 characters. This causes numerous variations in the spelling of the same port and thus causes poor representation to other ships and port authorities. As a solution to this problem, the IMO has advised the use of The United Nations Code for Trade and Transport Locations'; more commonly known as ‘UN/LOCODE’ which makes information related to the destination extremely unambiguous. The UN/LO-CODE is a product of the wide-ranging collaboration for trade facilitation undertaken by the United Nations. Currently, the UN/LOCODE has been assigned to 103,034 locations in 249 countries and installations in international waters. The disclosure thus employs the use of UN/LO CODE to great effect in order to ensure data integrity is not violated.

Association rule learning is a machine learning method for discovering relations between data and variables in large databases. It is intended to identify strong rules discovered in databases using some measures of interestingness. The ultimate goal, assuming a large enough dataset, is to help a machine mimic the human brain's feature extraction and abstract association capabilities from new uncategorized data. Support, Confidence and Lift significance measures are used in a combination to create a Cargo at Berth (C@B).

A process may be employed to collect information by scrapping records of the Statement of Facts (SOFs) and Ullage Reports and Port Call databases. The SOF logs events and allied changes in location and draught of a vessel. This accurate information is used to generate an accurate understanding of loading-discharging activities and the quantity of cargo loaded or discharged. The SOF events include headers like End of Sea Passage (EOSP), All Fast, Pilot on Board (POB), Last Line and Commencement of Sea Passage (COSP). Draught changes recorded for these events is an accurate indicator of loading-discharging activity and quantity of cargo.
Representative structured data stores may include one or more of the following datasets:
Vessel Position—Includes information related to berths, berth pathway points, pathway points, pathways, port approaches, port areas, SOF details and vessels positions.
Vessel—Includes information related to the global fleet of vessels with regards to companies, operators, ship builders, technical managers, vessel characteristics etc.
Crude Oil—Includes information related to crude oil blends, loading locations, synonyms, trade names, Oil fields, Parcel Sizes, Loading Rates, Pricing Baskets, C@B assignments basis, Association rule learning etc.
Locations—Includes information related to berths, terminals, ports, countries, regions, continents. Areas are demarcated by polygons which in turn allow easy filtering by specified location.
Other Cargo—information for various bulk-shipping cargos.
   Extracting Information from Lineups

Along with commercial information suppliers, information may be procured from global vessel lineups confirmed by local agents. These lineups provide critical information related to the vessel, cargo, charterer, shipper. The lineups are procured in many formats from agents and information houses from around the world. The lineups are processed and fed into a continuously updating lineups database algorithmically. The algorithms transform the lineups from various formats into one standardized format. The standardized format contains information to effectively understand the future route of a vessel by populating the ‘PREVIOUS_PORT’ and ‘PORT_LINEUP’ fields in the database. In some cases, the lineups provided by agents also make the prospective terminal and berth information available. Following are representative fields and their classification:

| Category | Fields |
|---|---|
| Report | report_date, report_provider |
| Vessel | vessel_imo, vessel_dwt, vessel_type |
| Port | port_lineup, terminal_lineup, berth_lineup |
| Cargo | cargo_lineup, cargo_type_lineup, cargo_quantity, units |
| Operations | eta, pob, etb, etd, ata, atd, atd, delay_days |
| Business | shipper, receiver, charterer |

Attention is drawn to the REPORT_DATE, REPORT_PROVIDER fields which allow insights into the agency by which the report is provided and on which the data has been transformed by the proprietary algorithms. The VESSEL fields provide all the required information to accurately identify the vessel and then relate the vessel structural and operational characteristics of the vessel for further processing in the data models for predicting the cargo operations.

The PORT fields contain information related to the port/terminal or berth at which the port-call will occur. In some cases, terminals and berths are provided by agents. Algorithms employing spatial functions are used to populate these fields for cases with missing data points. An additional dataset which categorizes terminals/berths as wet or dry may aid an algorithm to optimize its search and populate the missing data in the terminal/berth fields.

The CARGO fields provide all critical insights into the cargo that will be loaded on the vessels along with the sub-type of the cargo. For crude oil, the sub-type is the blend of the crude oil. For example, the crude oil blend ‘Murban’ will be specified when the vessel is slated to be in Jebel Dhana or in Fujairah. The cargo quantity denoted the quantity to be shipped and the units field specifies the units of measurement used for the transaction.

The OPERATIONS fields are critical in cases where limited information is available, and some information needs to be derived. These fields are populated based on a combination of SOFs and AIS data. The SOFs provide a strictly chronological sequence of events and thus aid in understanding the vessel operations to the core. The timestamps on these events may provide valuable information in deciphering the shipping patterns alongside confirming other fields in the dataset.

The BUSINESS fields are important identifiers for developing association rules, clustering paradigms and other advanced data models like neural networks which help in significantly improving the quality of the data. Hidden and obvious patterns can be unearthed using these algorithms so as to impute missing data points.

Extracting Information from Berthing Schedules & Plans

Apart from Lineups information from the berthing plans, berthing schedules or daily ship loading plans may be employed in certain embodiments. These plans or schedules are an effective way of corroborating the lineup data received from the agents. These plans confirm the berthing of ships in a particular port at a particular berth.

From the berthing plan or schedule, information is corroborated and updated into the lineups database as describe herein. The berthing plans provide detailed information with regards to ‘time alongside’. The ‘time alongside’ duration may be one of the important factors for determining the cargo and the vessel. The ‘time alongside’ concept explains the size of the vessel in tandem with other parameters like ‘load_rate’ and ‘time_slot_operation’ from other supporting databases. Recurring activity for particular type of vessels helps in assigning the berth and by association the terminal to a particular type of cargo.

Extracting Information from Fixtures

This data indicates if a ship has been fixed for employment or not. The most beneficial part of the fixtures data is that the fixtures can be acquired well in advance, thus allowing ample time for accurate research before finalizing a particular cargo loading/unloading. The fixtures data may be used to fill up the gaps in the above sources; namely lineups and berthing plans. This database contains a field named ‘fulfilled’ which ay be a logical operator with values ′1 or ′0. This field is useful while optimizing search and focusing only on the fulfilled fixtures. The following are representative fields from the FIXTURES database along with its classification:

| Category | List of fields |
|---|---|
| Report | Report_date, report_provider |
| Vessel | Vessel_IMO, vessel_dwt, |
| Port | Port_lineup, terminal_lineup, berth_lineup |
| Cargo | Cargo_lineup, cargo_type_lineup, cargo_quantity, units |
| Operations | Laycan from, Laycan to |
| Business | Shipper, receiver, charterer |

The OPERATIONS category contains the ‘LAYCAN FROM’ and ‘LAYCAN TO’ fields which provide information about the LAYCAN duration. LAYCAN or Laydays Canceling is defined as the period during which the shipowner must tender notice of readiness to the charterer that the ship has arrived at the port of loading and is ready to load. This period is expressed as two dates. These fields also provide a clear indication of the vessel's estimated ETA. Along with this, the fixtures data provides valuable information that is used to confirm the data generated from AIS and other sources.

Extracting Information from Reports

### Next Port

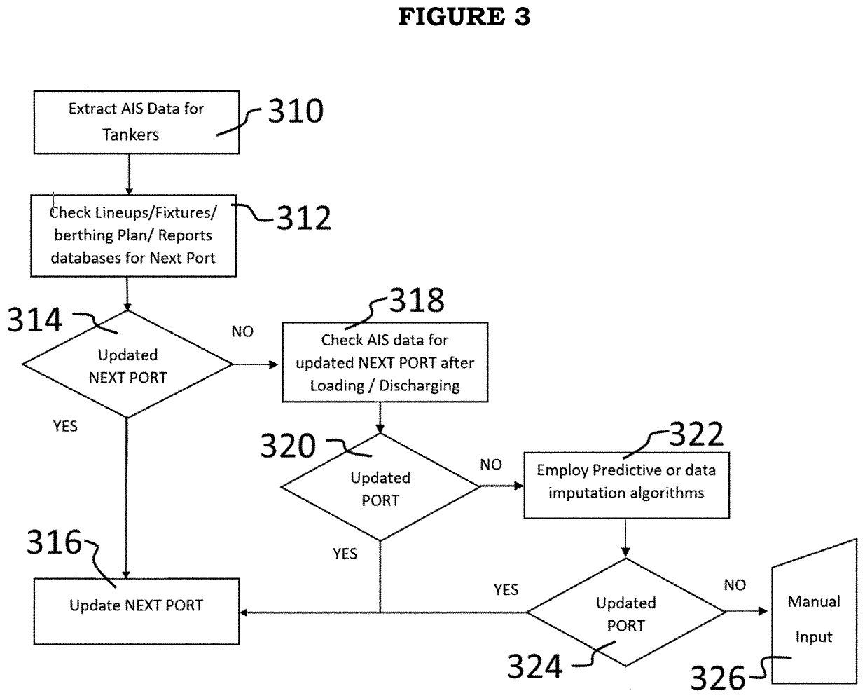

FIG. 3 shows a method of extracting data from reports to predict the next port for a journey of an oil tanker. In FIG. 3 the method starts at a step 310 where AIS data is extracted for tankers. At a step 312 the associated documents for the tanker are searched for an entry in the Next Port data field. At a step 314, if the next port information is sufficient, the method proceeds to a step 316. If not, it proceeds to a step 318.

At a step 318 the AIS data for that vessel is tested for Next Port information after loading or unloading. At a step 320, if the AIS data provides the updated Next Port information, then proceed to step 316. If not, the method proceeds to step 322 where predictive analytics are performed.

At a step 324 the results of the action in step 322 is tested to determine if the Next Port filed is updated. If not, the method proceeds to step 326 where the data may be entered manually. If so, the method proceeds to a step 316.

At a step 316 the Next Port field is updated, and the method ends.

### Cargo Data

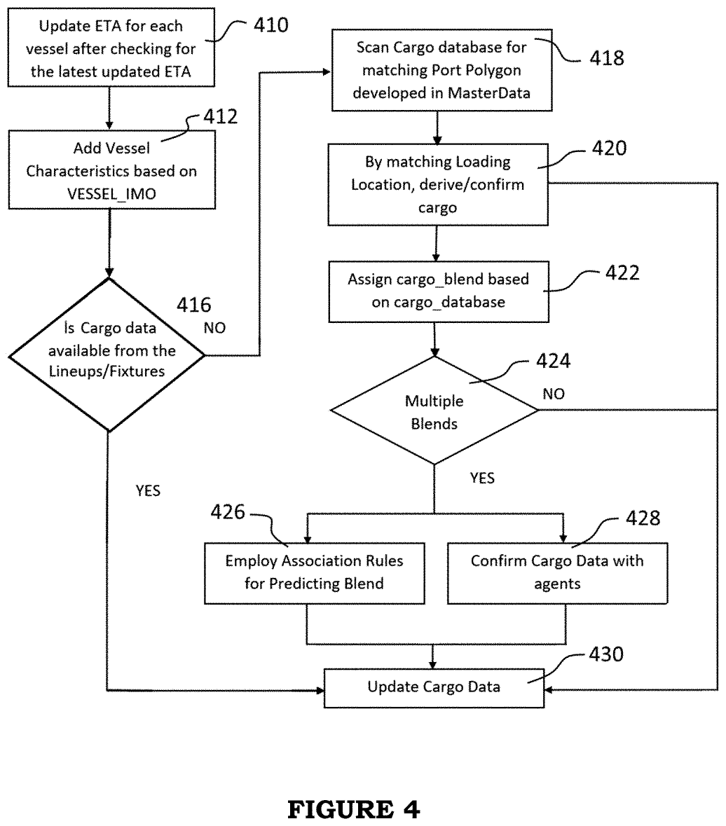

FIG. 4 is a flow diagram of a method for updating cargo data. The method begins at a step 410 where the estimated time of arrival (ETA) is confirmed and recorded.

At a step 412 the vessel characteristics, based on the vessel IMO, is recorded.

At a step 416 the lineups or fixtures is queried is determine if cargo data is available from them. If it is, flow proceeds to a step 430. If not, flow proceeds to a step 418.

At the step 418 a cargo database is queried to identify matching port polygons or other geographic information that may indicate the cargo.

At a step 420 if matching loading or location information indicates cargo, proceed to the step 430. If not proceed to a step 422.

At the step 422 assign cargo blend based on information in a cargo database.

At a step 424 the cargo data is queried for an indication of multiple blends. If multiple blends are indicated, then flow proceeds to a step 426 or 428 depending on cargo data from agents, if not flow proceeds to step 430.

At the step 426 association rules are employed to predict the blend and flow proceeds to the step 430.

At the step 428 the cargo is confirmed with agents and flow proceeds to the step 430.

At the step 430 the cargo data is updated, and the method ends.

### Advanced Data Models

Clean, verified data is suitable for use in the predictive models. Association rule mining is a methodology to find most frequent transactions and generate an overview of possible outcomes. Accordingly, the cargo flow between ports can be considered to be transactions and hence association rule mining becomes a viable method for modelling the data.

Loading multiple blends at a single location is a common phenomenon in the crude oil and clean petroleum products (CPP) market. The best example for this phenomenon would be the Port of Ras Tanura in Saudi Arabia. Ras Tanura is one of the largest crude oil export locations in the world. Ras Tanura is complemented by the newer port of Juaymah for the export of crude oil. This location is used to ship out multiple Saudi Arabian Crude Oil blends like Arab Heavy, Arab Medium, Arab Light, Arab Super Light, Arab Extra Light, Yaarabe etc. It is impossible to differentiate between the crude oil blends loaded onboard the vessels as it may be individual blends or a combination of both. This multiple blends phenomenon exists in all major crude oil exporting locations. In such embodiments, it may be imperative to use the advanced predictive techniques as well as support from the network of agents and the port authorities. The association rules created depend on various categorical variables like Shipper, Charterer, Receiver, Country of Origin, Deadweight bracket, Historical Routes etc. to predict the missing data in the terminals. Based on the results of association rule modeling as well as other predictive methods like neural networks, missing data can be imputed with significant accuracy. The algorithm may also check the historical loading/discharging activity in the mentioned port.

### Port Restrictions Database

A port restrictions database may contain information related to the operational capabilities of ports. These characteristics play a crucial role in ascertaining the vessel arrivals, vessel sizes and by extension the blend by taking into consideration parameters like load rate, crane capacities, operational timings, length of the berths, draught of the channel etc.

Port restrictions database are commercially available and may include fields like max arrival draught, max sailing draught, max DWT acceptable. These types of fields aid the algorithm in ascertaining the size of the vessels that can be accommodated at certain berths as confirmed by the Port Authorities. This information also provides details about the loading activity. For example, In Juaymah, the minimum loading rate is 25,000 barrels per hour and the maximum loading rate is 110,000 barrels per hour. If a vessel loads for 9 hours at the same berth, it is safe to conclude that only one blend was loaded. On the contrary, if a vessel loads and departs after an extended stay, a strong possibility arises for multiple blends being loaded. Depending on this information and insights generated by the data models, the blends can be ascertained with reasonable accuracy.

### Cargo Quantity

Similar to other data collection, the cargo quantity may be ascertained using information from the lineups/fixtures and from the agents. Some embodiments of the current disclosure may use vessel draft information to calculate TPCI, while others may use association rules or other predictive analytics. Once a cargo is determined, AIS information may be employed to verify the accuracy of the determination. For example, and without limitation, changes in vessel draft or movement may confirm cargo prediction.

The cargo quantity may play a crucial role in formulating operational strategies for shipping companies and by extension supply chain companies too. Information related to cargo quantity can be extracted from the reports, lineups and fixtures database with significant level of certainty. However, to fill up the gaps in the data, an algorithm was developed to estimate the quantity. Cargo quantity is a function of the vessel's draught. Taking advantage of this information and using other naval architecture parameters such as block coefficient, waterplane area, and the like, to estimate the quantity, the algorithm predicts the missing data points with increased accuracy. The algorithm may not wholly rely on the draught change patterns but may also take into consideration probabilities developed using advanced data models like rule mining, neural networks etc. This consideration is important because using only a numeric approach tends to over-rely on computation prowess of the algorithm. Considering qualitative attributes to supplement the quantitative ones provides great insights into the data. The combination is a more sophisticated way of filling up missing data as it optimizes both paradigms. The algorithm in the figure above describes a way of assigning both; ‘Cargo Operation’ and ‘Cargo quantity’ to a particular transaction. First, the algorithm scans information provided by agents, brokers and information houses to extract the cargo operation and cargo quantity data and updates if found. If data is not available, the proprietary algorithms predict the cargo operation and cargo quantity based on the models described above.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and, in a manner, consistent with the scope of the invention, as set forth in the following claims.

What is claimed:

1. A method for cargo volume analysis including:
receiving AIS information at a server, said server coupled to a network, wherein said AIS information includes at least a vessel draft information and a location information;
calculating a TPCI based on the vessel draft information;
determining cargo type from the location information using predictive analytics;
predicting a crude oil blend using prediction analytics, and
determining the cargo volume from said predicting.

2. The method of claim 1 wherein the prediction analytics includes applying association rules to a historical dataset.

3. The method of claim 2 wherein the association rules include information about the most frequent transactions and generates the most likely transactions.

4. The method of claim 1 wherein prediction analytics includes using an artificial neural network based on a historical dataset.

5. A method for analyzing maritime cargo including the steps of:
receiving AIS information at a server, said server coupled to a network, said AIS information includes at least a vessel draft information and a location information;
processing the AIS information to remove outliers, incomplete information, and to standardize the information format;
effectuating association rules in response to said processing;
applying the association rules in response to a query received at the server, and
responding to the query with the results of the applying.

6. The method of claim 5 wherein the association rules are based on historic cargo information.

7. The method of claim 5 wherein the responding to the query includes a response with a crude oil blend information.

8. The method of claim 5 wherein the association rules include information about the most frequent transactions and generates the most likely transactions.

9. One or more processor-readable storage devices, said devices including non-transitory processor instructions directing a processor to perform a method including:
receiving AIS information wherein said AIS information includes at least a vessel draft information and a location information;
calculating a TPCI based on the vessel draft information;
determining cargo type from the location information using predictive analytics;
predicting a crude oil blend using prediction analytics, and
determining the cargo volume from said predicting

10. The device of claim 9 wherein the prediction analytics includes applying association rules to a historical dataset.

11. The device of claim 9 wherein the association rules include information about the most frequent transactions and generates the most likely transactions.

12. The device of claim 9 wherein prediction analytics includes using an artificial neural network based on a historical dataset.
